(19) United States
(12) Patent Application Publication
(10) Pub. No.: US 2023/0098130 A1
(43) Pub. Date: Mar. 30, 2023

(54) CURRENT COLLECTOR, POWER STORAGE ELEMENT, AND POWER STORAGE MODULE

(71) Applicant: TDK CORPORATION, Tokyo (JP)

(72) Inventor: Akinobu NOJIMA, Tokyo (JP)

(73) Assignee: TDK CORPORATION, Tokyo (JP)

(21) Appl. No.: 17/802,645

(22) PCT Filed: Mar. 27, 2020
(86) PCT No.: PCT/JP2020/014259

§ 371 Date: Aug. 26, 2022

(51) Int. Cl. H01M 4/66; H01M 4/70; H01M 10/0562; H01M 4/38

(52) U.S. Cl. CPC H01M 4/66; H01M 4/70; H01M 4/382; H01M 10/0562; H01M 10/0525

(57) ABSTRACT

A resin layer that has a first surface, and a second surface facing a side opposite to the first surface; a first metal layer that is provided on the first surface of the resin layer; and a second metal layer that is provided on the second surface of the resin layer, wherein the first metal layer has a first opening.

### TECHNICAL FIELD

The present disclosure relates to a current collector, a power storage element, and a power storage module.

### BACKGROUND ART

Lithium ion secondary batteries are widely used as power sources for mobile devices such as portable telephones and laptop computers, hybrid cars, and the like. With development in these fields, lithium ion secondary batteries are required to have higher performance.

For example, Patent Document 1 discloses a resin current collector. The resin current collector includes a resin layer, and metal layers that are formed on both surfaces thereof. A secondary battery using a resin current collector has a high output density per weight.

### PRIOR ART DOCUMENTS

### Patent Document

Patent Document 1: PCT International Publication No. WO2019/031091

### DISCLOSURE OF INVENTION

### Problems to Be Solved by the Invention

Electric power generated inside a power storage battery is output to an external device via a tab connected to a current collector. The tab is connected to the current collector by bonding, welding, screwing, or the like. A resin layer of a resin current collector has a smaller strength than a metal, and thus the resin layer may break when a tab is connected thereto and two metal layers sandwiching the resin layer therebetween may be short-circuited.

The present disclosure has been made in consideration of the foregoing problems, and an object thereof is to provide a current collector and a power storage element which are unlikely to be short-circuited, and a power storage module using these.

### Solutions for Solving the Problems

In order to resolve the foregoing problems, the following features are provided.

(1) A current collector according to a first aspect includes a resin layer that has a first surface, and a second surface facing a side opposite to the first surface; a first metal layer that is provided on the first surface of the resin layer; and a second metal layer that is provided on the second surface of the resin layer. The first metal layer has a first opening.

(2) In the current collector according to the foregoing aspect, the first opening may be at a position facing a metal plate bonding location of the second metal layer for bonding a metal plate implementing electrical connection to an external device.

(3) In the current collector according to the foregoing aspect, the first metal layer may have a first region and a second region. The first region and the second region may be separated from each other by the first opening.

(4) In the current collector according to the foregoing aspect, the second metal layer may have a second opening.

(5) In the current collector according to the foregoing aspect, the second opening may be at a position facing a metal plate bonding location of the first metal layer for bonding a metal plate implementing electrical connection to an external device.

(6) In the current collector according to the foregoing aspect, the second metal layer may have a third region and a fourth region. The third region and the fourth region may be separated from each other by the second opening.

(7) In the current collector according to the foregoing aspect, the resin layer may be an insulating layer of 1.0×10⁹ Ω·cm or higher.

(8) In the current collector according to the foregoing aspect, the resin layer may include any one selected from the group consisting of polyethylene terephthalate (PET), polyimide (PI), polyamide imide (PAI), polypropylene (PP), and polyethylene (PE).

(9) In the current collector according to the foregoing aspect, each of the first metal layer and the second metal layer may be any one selected from aluminum, nickel, stainless steel, copper, platinum, and gold.

(10) In the current collector according to the foregoing aspect, the first metal layer and the second metal layer may include metals or alloys different from each other.

(11) A power storage element according to a second aspect includes the current collector according to the foregoing aspect, a first electrode that is formed on a first surface of the current collector, a second electrode that is formed on a second surface on a side opposite to the first surface of the current collector, and a separator or a solid electrolyte layer that is laminated on one surface of the first electrode or the second electrode.

### Effects of Invention

In the current collector and the power storage element according to the foregoing aspects, occurrence of a short circuit can be curbed.

### BRIEF DESCRIPTION OF DRAWINGS

FIG. 1 is a schematic view of a power storage element according to a first embodiment.

FIG. 2 is a cross-sectional view of an electrode body according to the first embodiment.

FIG. 3 is a developed cross-sectional view of the electrode body according to the first embodiment.

FIG. 4 is an enlarged plan view of a characteristic part of a current collector according to the first embodiment.

FIG. 5 is an enlarged cross-sectional view of a characteristic part of the current collector according to the first embodiment.

FIG. 6 is an enlarged plan view of a characteristic part of a current collector according to a first modification example.

FIG. 7 is an enlarged plan view of a characteristic part of a current collector according to a second modification example.

### EMBODIMENTS FOR CARRYING OUT THE INVENTION

Hereinafter, embodiments will be described in detail suitably with reference to the drawings. In the drawings used in the following description, in order to make characteristics easy to understand, characteristic portions may be illustrated in an enlarged manner for the sake of convenience, and dimensional ratios or the like of each constituent element may differ from actual values thereof. Exemplary materials, dimensions, and the like illustrated in the following description are merely examples. The present disclosure is not limited thereto and can be suitably changed and performed within a range not changing the features thereof.

Hereinafter, preferred examples of the present disclosure will be described in detail with reference to the accompanying drawings.

Examples of the present disclosure are provided to those skilled in the art of the technical field so as to describe the present disclosure in detail. The following Examples may be modified into various other forms, and the scope of the present disclosure is not limited to the following Examples.

In addition, in the following drawings, the thickness and the size of each layer are presented for the sake of convenience of description and clarity, and the same reference signs in the drawings indicate the same elements. As used in this specification, the term “and/or” includes any one and all combinations of one or more of the enumerated items.

The terms used in this specification are used for describing a particular example and are not intended to limit the present disclosure. As used in this specification, a singular form can include a plural form unless otherwise designated clearly in its context. In addition, when used in this specification, the term “include” identifies the presence of the shape, the number, the stage, the operation, the member, the element, and/or a group of these which have been mentioned and is not intended to exclude the presence or addition of one or more of other shapes, numbers, operations, members, elements, and/or groups thereof.

Space-related terms such as “lower portion”, “below”, “low”, “upper portion”, “above”, “left”, and “right” may be utilized for easy understanding of one element or characteristic with respect to other elements or characteristics illustrated in the drawings. Such space-related terms are intended to facilitate understanding of the present disclosure in terms of various states of steps or states of usage of the present disclosure and are not intended to limit the present disclosure. For example, if an element or a characteristic in the drawing is turned upside down, “lower portion” or “below” used for describing the element or the characteristic becomes “upper portion” or “above”. Therefore, “lower portion” indicates a concept covering “upper portion” or “below”. In addition, depending on the direction in which an element is viewed in the drawings, “left” and “right” may be reversed.

### First Embodiment

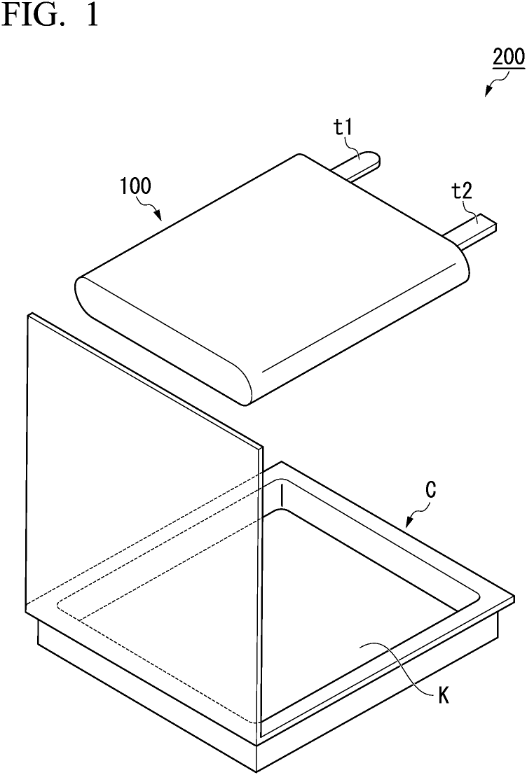

FIG. 1 is a schematic view of a power storage element according to the present embodiment. For example, a power storage element 200 is a lithium ion secondary battery that is a kind of nonaqueous electrolytic solution secondary battery. In FIG. 1, in order to facilitate understanding, a state immediately before an electrode body 100 is accommodated inside an exterior body C is illustrated.

The power storage element 200 includes the electrode body 100 and the exterior body C. A structure of the electrode body 100 will be described below. The electrode body 100 is accommodated in an accommodation space K of the exterior body C together with an electrolytic solution. The electrode body 100 has tabs t1 and t2 implementing electrical connection to an external device. The tabs t1 and t2 protrude outward from the inside of the exterior body C.

The tabs t1 and t2 are constituted to include a metal. For example, a metal is aluminum, copper, nickel, SUS, or the like.

For example, the tabs t1 and t2 have a rectangular shape in a view in a first direction (in a plan view in a z direction, which will be described below), but the shapes thereof are not limited to the foregoing shape and diverse shapes can be employed.

The exterior body C is intended to seal the electrode body 100 and the electrolytic solution inside thereof. The exterior body C inhibits leakage of the electrolytic solution to the outside, infiltration of moisture and the like into the electrode body 100 from the outside, and the like.

For example, the exterior body C is a metal laminate film in which a metal foil is coated with polymer films from both sides. For example, the metal foil is an aluminum foil, and for example, the polymer film is made of a resin such as polypropylene. For example, the polymer film on the outward side is made of polyethylene terephthalate (PET), polyamide, or the like, and for example, the polymer film on the inward side is made of polyethylene (PE), polypropylene (PP), or the like. In order to facilitate welding by heat, for example, the polymer film on the inward side has a lower melting point than the polymer film on the outward side.

An adhesive layer including an adhesive substance may be provided between the exterior body C and the electrode body 100. The exterior body C covers the outermost surface of the electrode body 100. An inner surface of the exterior body C faces the outermost surface of the electrode body 100. For example, the adhesive layer is located on a surface of the exterior body C facing the electrode body 100 (inner surface) or a surface of the electrode body 100 facing the exterior body C (the outermost surface of the electrode body). For example, the adhesive layer is a double-sided tape or the like which is resistant to an electrolytic solution. For example, the adhesive layer may be a layer which is obtained by forming an adhesive layer of polyisobutylene rubber on a polypropylene base material, a layer made of a rubber such as a butyl rubber, a layer made of a saturated hydrocarbon resin, or the like. The adhesive layer curbs movement of the electrode body 100 inside the exterior body C. In addition, even when a metal body such as a nail is stuck in the adhesive layer, the adhesive substance is entwined with a metal body such as a nail, and thus occurrence of a short circuit is curbed.

For example, the electrolytic solution is a nonaqueous electrolytic solution including a lithium salt or the like. The electrolytic solution is a solution in which an electrolyte is dissolved in a nonaqueous solvent, and it may contain cyclic carbonates and chain carbonates as nonaqueous solvents.

Cyclic carbonates solvate an electrolyte. For example, the cyclic carbonates are ethylene carbonate, propylene carbonate, butylene carbonate, or the like. Chain carbonates reduce a viscosity of cyclic carbonates. For example, the chain carbonates are diethyl carbonate, dimethyl carbonate, and ethyl methyl carbonate. Furthermore, chain carbonates may be used with methyl acetate, ethyl acetate, methyl propionate, ethyl propionate, propyl propionate, γ-butyrolactone, 1,2-dimethoxyethane, 1,2-diethoxyethane, or the like mixed thereinto. For example, a proportion of the cyclic carbonates : the chain carbonates is 1:9 to 1:1 in terms of volume ratio.

For example, in the nonaqueous solvent, a portion of hydrogen in the cyclic carbonates or chain carbonates may be substituted with fluorine. For example, the nonaqueous solvent may include fluoroethylene carbonate, difluoroethylene carbonate, or the like.

For example, the electrolyte is a lithium salt such as LiPF₆, LiClO₄, LiBF₄, LiCF₃SO₃, LiCF₃CF₂SO₃, LiC(CF₃SO₂)₃, LiN(CF₃SO₂)₂, LiN(CF₃CF₂SO₂)₂, LiN(CF₃SO₂)(C₄F₉SO₂), LiN(CF₃CF₂CO)₂, LiBOB, or the like. Regarding these lithium salts, one kind may be used alone, or two or more kinds may be used together. From a viewpoint of the degree of ionization, it is preferable to include LiPF₆ as an electrolyte.

When LiPF₆ is dissolved in the nonaqueous solvent, for example, the concentration of the electrolyte in the electrolytic solution is adjusted to 0.5 to 2.0 mol/L. If the concentration of the electrolyte is 0.5 mol/L or higher, the concentration of lithium ions in the nonaqueous electrolytic solution can be sufficiently secured, and a sufficient capacitance at the time of charging and discharging is likely to be obtained. In addition, when the concentration of the electrolyte is regulated to be 2.0 mol/L or lower, increase in coefficient of viscosity of the nonaqueous electrolytic solution can be restricted, mobility of lithium ions can be sufficiently secured, and thus a sufficient capacitance at the time of charging and discharging is likely to be obtained.

When LiPF₆ is mixed with other electrolytes as well, for example, it is preferable that the concentration of lithium ions in the nonaqueous electrolytic solution be adjusted to 0.5 to 2.0 mol/L and the concentration of lithium ions from LiPF₆ be equal to or higher than 50 mol% thereof.

For example, the nonaqueous solvent may have a room-temperature molten salt. A room-temperature molten salt is a salt which is obtained by a combination of cations and anions and is in a liquid state even if the temperature is lower than 100° C. Since a room-temperature molten salt is a liquid consisting of only ions, it has strong electrostatic interactions and is characterized by being non-volatile and nonflammable.

Regarding cation components of a room-temperature molten salt, there are nitrogen-based cations including nitrogen, phosphorus-based cations including phosphorus, sulfur-based cations including sulfur, and the like. Regarding these cation components, one kind may be included alone or two or more kinds may be included in combination.

Regarding nitrogen-based cations, there are chain or cyclic ammonium cations such as imidazolium cations, pyrrolidinium cations, piperidinium cations, pyridinium cations, and azoniaspiro cations.

Regarding phosphorus-based cations, there are chain or cyclic phosphonium cations.

Examples of sulfur-based cations include chain or cyclic sulfonium cations.

Particularly, as the cation component, N-methyl-N-propyl-pyrrolidinium (P13) that is nitrogen-based cation is preferable since this cation component has high lithium-ion conductivity and has wide resistance to oxidation and reduction when a lithium imide salt is dissolved therein.

Regarding anion components of a room-temperature molten salt, there are AlCl₄⁻, NO₂⁻, NO₃⁻, I⁻, BF₄⁻, PF₆⁻, AsF₆⁻, SbF₆⁻, NbF₆⁻, TaF₆⁻, F(HF)_{2.3}⁻, p—CH₃PhSO₃^{—}, CH₃CO₂⁻, CF₃CO₂⁻, CH₃SO₃⁻, CF₃SO₃⁻, (CF₃SO₂)₃C⁻, C₃F₇CO₂⁻, C₄F₉SO₃⁻, (FSO₂)₂N⁻ (bis(fluorosulfonyl)imide: FSI), (CF₃SO₂)₂N⁻ (bis(trifluoromethanesulfonyl)imide: TFSI), (C₂F₅SO₂)₂N⁻ (bis(pentafluoroethanesulfonyl)imide). (CF₃SO₂)(CF₃CO)N⁻ ((trifluoromethanesulfonyl)(trifluoromethanecarbonyl)imide), (CN)₂N⁻ (dicyanoimide), and the like. Regarding these anion components, one kind may be included alone or two or more kinds may be included in combination.

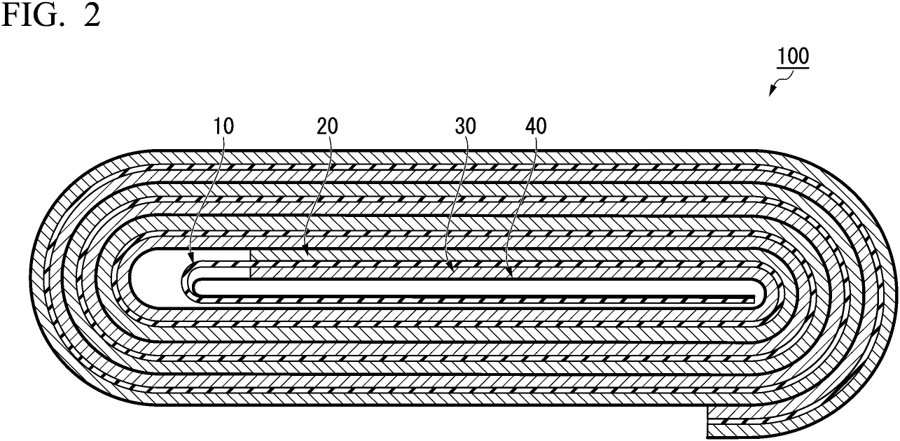

FIG. 2 is a cross-sectional view of the electrode body 100 according to the first embodiment. FIG. 2 is a cross section of the electrode body 100 orthogonal to a winding axis direction of the electrode body 100. The electrode body 100 is a wound body including a current collector 10, a positive electrode active material layer 20, a negative electrode active material layer 30, and a separator 40. For example, in the electrode body 100, the separator 40. the negative electrode active material layer 30, the current collector 10. and the positive electrode active material layer 20 are repeatedly wound from an inward winding side toward an outward winding side in this order. For example, the negative electrode active material layer 30 is on the inward winding side of the positive electrode active material layer 20. If the negative electrode active material layer 30 is on the inward winding side, an energy density of the power storage element 200 increases. This is because a weight of the negative electrode active material layer 30 is often lighter than a weight of the positive electrode active material layer 20, and even when negative electrodes face each other on the inward winding side, a loss of weight energy density is small.

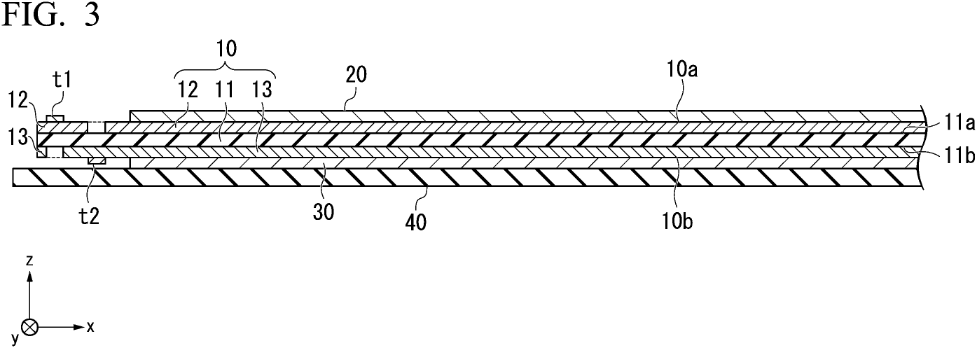

FIG. 3 is a developed cross-sectional view of the electrode body 100 according to the first embodiment. For example, the electrode body 100 is wound around a left end of FIG. 3 as a winding center.

In a developed body in which the electrode body 100 is developed, a lamination direction of layers will be referred to as the z direction. A direction from a second metal layer 13 toward a first metal layer 12 will be referred to as a positive z direction, and a direction opposite to the positive z direction will be referred to as a negative z direction. A direction within a plane where the developed body in which the electrode body 100 is developed expands will be referred to as an x direction, and a direction orthogonal to the x direction will be referred to as a y direction. For example, the x direction is a length direction of the developed body in which the electrode body 100 is developed. For example, the y direction is a width direction of the developed body in which the electrode body 100 is developed.

The electrode body 100 includes the current collector 10, the positive electrode active material layer 20. the negative electrode active material layer 30, and the separator 40. The positive electrode active material layer 20 is formed on a first surface 10a side of the current collector 10. The negative electrode active material layer 30 is formed on a second surface 10b side of the current collector 10. The second surface 10b is a surface on a side opposite to the first surface 10a in the current collector 10. The current collector 10 has the first surface 10a, and a second surface 20 facing a side opposite to the first surface 10a. The positive electrode active material layer 20 is an example of a first active material layer. The negative electrode active material layer 30 is an example of a second active material layer. The separator 40 comes into contact with the positive electrode active material layer 20 or the negative electrode active material layer 30. The separator 40 is located between the positive electrode active material layer 20 and the negative electrode active material layer 30 in a state in which the electrode body 100 is wound.

The current collector 10 includes a resin layer 11, the first metal layer 12. and the second metal layer 13. The first metal layer 12 is formed on a first surface 11a side of the resin layer 11. The second metal layer 13 is formed on a second surface 11b side of the resin layer 11. The second surface 11b is a surface on a side opposite to the first surface 11a in the resin layer 11. For example, the first metal layer 12 is a positive electrode current collector. For example, the second metal layer 13 is a negative electrode current collector. For example, the positive electrode active material layer 20 is formed on a surface of the first metal layer 12 on a side opposite to the resin layer 11. In this case, the first metal layer 12 and the positive electrode active material layer 20 form a positive electrode. For example, the negative electrode active material layer 30 is formed on a surface of the second metal layer 13 on a side opposite to the resin layer 11. In this case, the second metal layer 13 and the negative electrode active material layer 30 form a negative electrode. The relationship between the first metal layer 12 and the second metal layer 13 may be reversed. The first metal layer 12 may be a negative electrode current collector, and the second metal layer 13 may be a positive electrode current collector. The first metal layer 12 and the second metal layer need only be conductive layers.

The resin layer 11 is constituted to include a material having insulating properties. In this specification, insulating properties denote that a resistance value is 1.0×10⁹ Ω·cm or higher. For example, the resin layer 11 is an insulating layer having insulating properties. For example, the resin layer 11 includes any one selected from the group consisting of polyethylene terephthalate (PET), polyimide (PI), polyamide imide (PAI), polypropylene (PP), and polyethylene (PE). The resin layer 11 is not limited to the foregoing materials. For example, the resin layer 11 is a PET film. For example, a thickness of the resin layer 11 is 3 µm to 9 µm and is preferably 4 µm to 6 µm.

Each of the first metal layer 12 and the second metal layer 13 is any one selected from aluminum, nickel, stainless steel, copper, platinum, and gold. Each of the first metal layer 12 and the second metal layer 13 is not limited to these materials. For example, the first metal layer 12 and the second metal layer 13 include metals or alloys different from each other. For example, the first metal layer 12 is aluminum. For example, the second metal layer 13 is copper. The first metal layer 12 and the second metal layer 13 may be formed of the same materials. For example, both the first metal layer 12 and the second metal layer 13 are made of aluminum. Specific constitutions of the first metal layer 12 and the second metal layer 13 will be described below.

It is preferable that both the first metal layer 12 and the second metal layer 13 be constituted using aluminum or the first metal layer 12 and the second metal layer 13 be constituted such that one of the first metal layer 12 and the second metal layer 13 is made of aluminum and the other is made of copper.

The thicknesses of the first metal layer 12 and the second metal layer 13 may be the same or different from each other. For example, the thicknesses of the first metal layer 12 and the second metal layer 13 are preferably 0.3 µm to 2 µm and are preferably 0.4 µm to 1 µm.

For example, the first metal layer 12 is thicker than the resin layer 11. If the first metal layer 12 is thicker than the resin layer 11, the weight energy density is improved and deterioration in flexibility is curbed.

For example, the second metal layer 13 is thicker than the resin layer 11. If the second metal layer 13 is thicker than the resin layer 11, the weight energy density is improved and deterioration in flexibility is curbed.

In addition, the thickness of the resin layer 11 may be larger than the sum of the thickness of the first metal layer 12 and the thickness of the second metal layer 13. If the constitution is satisfied, deterioration in flexibility of the current collector 10 can be further curbed. In addition, since a rate of the resin layer 11 having a low specific weight as a proportion in the current collector 10 increases, the weight energy density of the power storage element using this is improved.

For example, the positive electrode active material layer 20 includes positive electrode active materials, conductive additives, and binders.

The positive electrode active materials can reversibly proceed absorbing and desorbing of lithium ions, separation and intercalation of lithium ions, or doping and de-doping of lithium ions and counter anions.

For example, the positive electrode active materials are lithium cobaltate (LiCoO₂), lithium nickelate (LiNiO₂), lithium manganate (LiMnO₂), lithium manganese spinel (LiMn₂O₄), complex metal oxide expressed by general formula: LiNiₓCo_{y}Mn_{z}MₐO₂ (x+y+z+a=1, 0≤x<1, 0≤y<1, 0≤z<1, 0≤a<1, and M is one or more kinds of elements selected from Al, Mg, Nb, Ti, Cu, Zn, and Cr), a lithium vanadium compound (LiV₂O₅), olivine-type LiMPO₄ (M indicates one or more kinds of elements selected from Co, Ni, Mn, Fe, Mg, Nb, Ti, Al, and Zr, or VO), lithium titanate (Li₄Ti₅O₁₂), complex metal oxide such as LiNiₓCo_{y}Al_{z}O₂ (0.9<x+y+z<1.1), polyacetylene, polyaniline, polypyrrole, polythiophene, polyacene, or the like. In addition, the positive electrode active materials may be mixtures of these.

The conductive additives are dotted inside the positive electrode active material layer. The conductive additives enhance the conductivity between the positive electrode active materials in the positive electrode active material layer. For example, the conductive additives are carbon powder such as carbon blacks, carbon nanotubes, carbon materials, fine powder of a metal such as copper, nickel, stainless steel, or iron, a mixture of a carbon material and a metal fine powder, or conductive oxide such as ITO. It is preferable that the conductive additives be carbon materials such as carbon black. When sufficient conductivity can be secured with active materials, the positive electrode active material layer 20 may not include conductive additives.

The binders bind the positive electrode active materials to each other in the positive electrode active material layer. Known binders can be used as the binders. For example, the binders are fluororesins. For example, fluororesins are polyvinylidene fluoride (PVDF), polytetrafluoroethylene (PTFE), a tetrafluoroethylene-hexafluoropropylene copolymer (FEP), a tetrafluoroethylene-perfluoroalkyl vinyl ether copolymer (PFA), an ethylene-tetrafluoroethylene copolymer (ETFE), polychlorotrifluoroethylene (PCTFE), an ethylene-chlorotrifluoroethylene copolymer (ECTFE), polyvinyl fluoride (PVF), or the like.

In addition to the above-described materials, for example, the binders may be vinylidene fluoride-based fluororubber such as vinylidene fluoride-hexafluoropropylene-based fluororubber (VDF-HFP-based fluororubber), vinylidene fluoride-hexafluoropropylene-tetrafluoroethylene-based fluororubber (VDF-HFP-TFE-based fluororubber), vinylidene fluoride-pentafluoropropylene-based fluororubber (VDF-PFP-based fluororubber), vinylidene fluoride-pentafluoropropylene-tetrafluoroethylene-based fluororubber (VDF-PFP-TFE-based fluororubber), vinylidene fluoride-perfluoromethyl vinyl ether-tetrafluoroethylene-based fluororubber (VDF-PFMVE-TFE-based fluororubber), and vinylidene fluoride-chlorotrifluoroethylene-based fluororubber (VDF-CTFE-based fluororubber).

For example, the positive electrode active material layer 20 is thicker than the current collector 10. When the constitution is satisfied, the capacitance and the volume energy density of the power storage element using the current collector 10 are further enhanced.

A capacitance loss inside the power storage element is further reduced by increasing the thickness of the positive electrode active material layer 20 causing a charging/discharging reaction with respect to the current collector 10 not causing a charging/discharging reaction. In addition, when the thickness of the current collector 10 is larger than the thickness of the positive electrode active material layer 20, the proportion of the current collector 10 having a high flexibility increases. Therefore, the rigidity of the electrode body 100 produced using this decreases, and the electrode body 100 is likely to be deformed.

The negative electrode active material layer 30 includes negative electrode active materials. In addition, as necessary, it may include conductive additives, binders, and solid electrolytes.

The negative electrode active materials need only be compounds capable of absorbing and desorbing ions, and negative electrode active materials used in known lithium ion secondary batteries can be used. For example, the negative electrode active materials are metal lithium; lithium alloys; carbon materials such as graphite capable of absorbing and desorbing ions (natural graphite or artificial graphite), carbon nanotubes, hardly graphitizable carbon, easily graphitizable carbon, and low-temperature baked carbon; a metalloid or a metal such as aluminum, silicon, tin, or germanium which can be chemically combined with a metal such as lithium; amorphous compounds mainly including oxide such as SiOₓ (0<x<2) or tin dioxide; or particles including lithium titanate (Li₄Ti₅O₁₂) or the like.

As described above, for example, the negative electrode active material layer 30 may include silicon, tin, or germanium. Silicon, tin, or germanium may be present as a single element or may be present as a compound. For example, a compound is an alloy and oxide. As an example, when the negative electrode active materials are silicon, the negative electrode may be referred to as a Si negative electrode. For example, the negative electrode active materials may be a mixed system of a simple substance or a compound of silicon, tin, and germanium and a carbon material. For example, a carbon material is natural graphite. In addition, for example, the negative electrode active materials may be a simple substance or a compound of silicon, tin, and germanium of which a surface is covered with carbon. A carbon material and covered carbon enhance the conductivity between the negative electrode active materials and a conductive additive. If the negative electrode active material layer includes silicon, tin, or germanium, the capacitance of the power storage element 200 increases.

As described above, for example, the negative electrode active material layer 30 may include lithium. Lithium may be metal lithium or a lithium alloy. The negative electrode active material layer 30 may be made of metal lithium or a lithium alloy. For example, a lithium alloy is an alloy of one or more kinds of elements selected from the group consisting of Si, Sn, C, Pt, Ir, Ni, Cu, Ti, Na, K, Rb, Cs, Fr, Be, Mg, Ca, Sr, Sb, Pb, In, Zn, Ba. Ra, Ge, and Al, and lithium. As an example, when the negative electrode active materials are metal lithium, the negative electrode may be referred to as a Li negative electrode. The negative electrode active material layer 30 may be a lithium sheet.

The negative electrode may consist of a negative electrode current collector (second metal layer 13) without having the negative electrode active material layer 30 at the time of production. If the power storage element 200 is charged, metal lithium is precipitated on a surface of the negative electrode current collector. Metal lithium is lithium of a simple substance in which lithium ions are precipitated, and metal lithium functions as a negative electrode active material layer.

Regarding the conductive additives and the binders, materials similar to those of the positive electrode active material layer 20 can be used. In addition to those exemplified in the positive electrode active material layer 20, for example, the binders in the negative electrode active material layer 30 may be cellulose, styrene butadiene rubber, ethylene propylene rubber, a polyimide resin, a polyamide imide resin, an acrylic resin, or the like. For example, cellulose may be carboxymethyl cellulose (CMC).

For example, the negative electrode active material layer 30 is thicker than the current collector 10. When the constitution is satisfied, the capacitance and the volume energy density of the power storage element using the current collector 10 are further enhanced.

A capacitance loss inside the power storage element is further reduced by increasing the thickness of the negative electrode active material layer 30 causing a charging/discharging reaction with respect to the current collector 10 not causing a charging/discharging reaction. In addition, when the thickness of the current collector 10 is larger than the thickness of the negative electrode active material layer 30, the proportion of the current collector 10 having a high flexibility increases. Therefore, the rigidity of the electrode body 100 produced using this decreases, and the electrode body 100 is likely to be deformed.

For example, the separator 40 has an electrically insulating porous structure. Examples of the separator 40 include a single layer body of a film consisting of polyolefin such as polyethylene or polypropylene; a stretched film of a laminate and a mixture of the foregoing resins; and fibrous nonwoven fabric made of at least one kind of constituent materials selected from the group consisting of cellulose, polyester, polyacrylonitrile, polyamide, polyethylene, and polypropylene.

For example, the thickness of the separator 40 is larger than the thickness of the resin layer 11. In addition, for example, the thickness of the separator 40 is larger than the thickness of the current collector 10. When a thicker separator is used, the separator is preferentially insulated so that occurrence of a short circuit between the first metal layer 12 and the second metal layer 13 which may occur in the current collector 10 can be curbed.

In place of the separator 40, a solid electrolyte layer may be provided. When a solid electrolyte layer is used, an electrolytic solution is no longer necessary. A solid electrolyte layer and the separator 40 may be used together.

For example, the solid electrolyte is an ion conductive layer of which the ion conductivity is 1.0×10⁻⁸ S/cm or higher and 1.0×10⁻² S/cm or lower. For example, the solid electrolyte is a polymer solid electrolyte, an oxide-based solid electrolyte, or a sulfide-based solid electrolyte. For example, the polymer solid electrolyte is an electrolyte in which an alkali metal salt is dissolved in a polyethylene oxide-based polymer. For example, the oxide-based solid electrolyte is Li_{1.3}Al₀_{.}₃Ti₁_{.}₇(PO₄)₃ (NASICON type), Li_{1.07}Al_{0.69}Ti_{1.}₄₆(PO₄)₃ (glass ceramics), Li_{0.34}La_{0.51}TiO_{2.}₉₄ (Perovskite type), Li₇La₃Zr₂O₁₂ (garnet type), Li_{2.9}PO_{3.3}N_{0.46} (amorphous, LIPON), 50Li₄SiO₄·50Li₂BO₃ (glass), or 90Li₃BO₃·10Li₂SO₄ (glass ceramics). For example, the sulfide-based solid electrolyte is Li_{3.25}Ge_{0.25}P_{0.75}S₄ (crystal), Li₁₀GeP₂S₁₂ (crystal, LGPS). Li₆PS₅Cl (crystal, argyrodite type). Li_{9.54}Si_{1.74}P_{1.44}S_{11.7}Cl_{0.3} (crystal), Li_{3.25}P_{0.95}S₄ (glass ceramics), Li₇P₃S₁₁ (glass ceramics), 70Li₂S·30P₂S₅ (glass), 30Li₂S·26B₂S₃·44LiI (glass), 50Li₂S·17P₂S₅·33LiBH₄ (glass), 63Li₂S·36SiS₂·Li₃PO₄ (glass), or 57Li₂S·38SiS₂·5Li₄SiO₄ (glass).

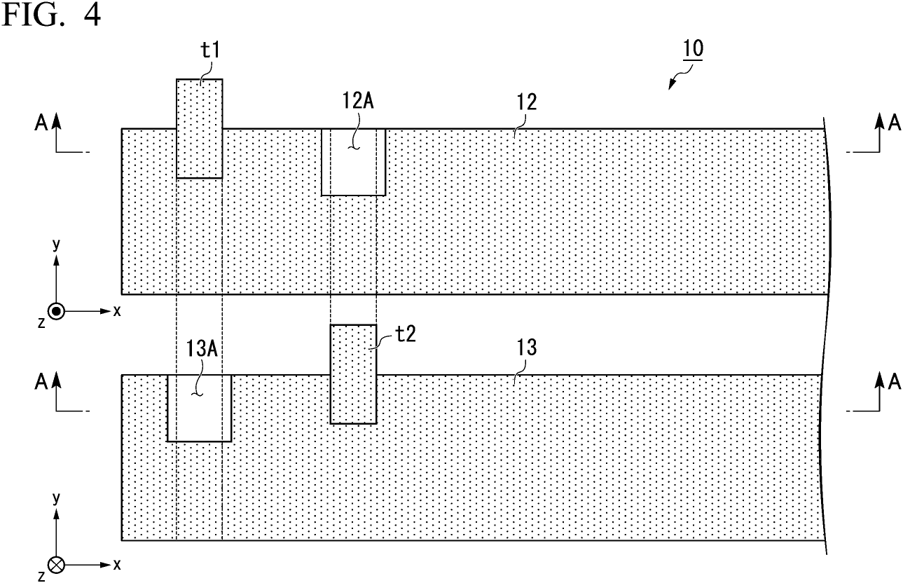

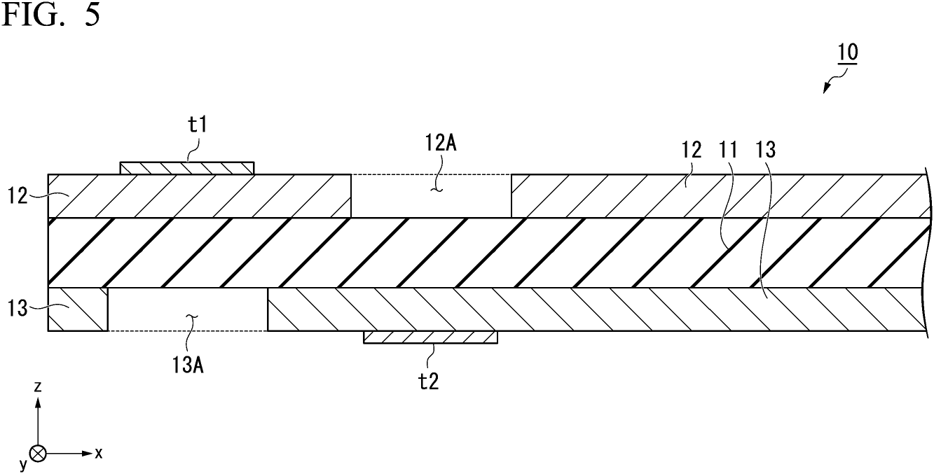

FIG. 4 is an enlarged plan view of a characteristic part of the current collector 10 according to the first embodiment. FIG. 5 is an enlarged cross-sectional view of a characteristic part of the current collector 10 according to the first embodiment. FIG. 5 is a cross section along line A-A in FIG. 4.

The tab t1 is connected to the first metal layer 12 For example, the tab t1 is provided on a surface of the first metal layer 12 on a side opposite to the resin layer 11. The tab t1 is an example of a first metal plate. The tab t2 is connected to the second metal layer 13. For example, the tab t2 is provided on a surface of the second metal layer 13 on a side opposite to the resin layer 11. The tab t2 is an example of a second metal plate. The tabs t1 and t2 implement electrical connection to an external device. The tab t1 is connected to the first metal layer 12 by bonding, welding, screwing, or the like. In addition, the tab t2 is connected to the second metal layer 13 by bonding, welding, screwing, or the like. For example, the tab t1 is welded to the first metal layer 12 by ultrasonic waves. In addition, for example, tab t2 is welded to the second metal layer 13 by ultrasonic waves.

The first metal layer 12 has an opening 12A. The second metal layer 13 has an opening 13A. In a plan view in the z direction, the opening 12A is on a side opposite to a region of the second metal layer 13 to which the tab t2 is connected with the resin layer 11 sandwiched therebetween. In a plan view, at least a portion of the opening 12A has a part overlapping at least a portion of the tab t2. In a plan view, the opening 13A is on a side opposite to a region of the first metal layer 12 to which the tab t1 is connected with the resin layer 11 sandwiched therebetween. In a plan view, at least a portion of the opening 13A has a part overlapping at least a portion of the tab t1. The openings 12A and 13A lead to the resin layer 11. The resin layer 11 is exposed at positions of the openings 12A and 13A.

Next, a method for manufacturing a power storage element will be described. First, metal layers are formed on both surfaces of a commercially available resin film. For example, metal layers can be formed by a sputtering method, a chemical vapor deposition method (CVD method), or the like.

Next, the metal layers at positions facing the locations for bonding the tabs t1 and t2 are removed. For example, the metal layers can be removed by a photolithography method or the like. Further, after portions of the metal layers are removed, the tabs t1 and t2 are bonded at positions facing the removed parts. For example, the tabs t1 and t2 are welded to the metal layers by ultrasonic waves. The tabs t1 and t2 may be bonded to the metal layers, may be screwed thereto, or may be welded thereto by heat or the like. The tabs t1 and t2 may be bonded after the positive electrode active material layer 20 and the negative electrode active material layer 30 are laminated and the positive electrode active material layer 20 and the negative electrode active material layer 30 at the tab bonding locations are removed.

Next, a surface of one metal layer (first metal layer 12) is coated with positive electrode slurry. The positive electrode slurry is obtained by mixing positive electrode active materials, binders, and a solvent and making the mixture into a paste. For example, the positive electrode slurry can be coated by a slit die coating method, a doctor blade method, or the like.

A solvent in the positive electrode slurry after coating is removed. A removal method is not particularly limited. For example, the current collector 10 coated with the positive electrode slurry is dried at a temperature of 80° C. to 150° C. in an atmosphere. Next, the obtained coated film is pressed so as to increase the density of the positive electrode active material layer 20. For example, regarding the pressing device, a roll press machine, an isostatic pressing machine, or the like can be used.

Next, a surface of the metal layer (second metal layer 13) on a side opposite to the surface coated with the positive electrode slurry is coated with negative electrode slurry. The negative electrode slurry is obtained by mixing negative electrode active materials, binders, and a solvent and making the mixture into a paste. The negative electrode slurry can be coated by a method similar to that of the positive electrode slurry. A solvent in the negative electrode slurry after coating is removed by drying: and thereby, the negative electrode active material layer 30 is obtained. When the negative electrode active materials are metal lithium, a lithium foil may be adhered to the second metal layer 13.

Next, the separator 40 is provided at a position where it comes into contact with the positive electrode active material layer 20 or the negative electrode active material layer 30, and the resultant laminate is wound around one end side as an axis. Thereafter, the electrode body 100 together with an electrolytic solution are sealed inside the exterior body C. Sealing is performed while decompression and heating are performed so that the electrolytic solution is impregnated into the electrode body 100. After the exterior body C is sealed by heat or the like, the power storage element 200 is obtained.

The current collector 10 according to the first embodiment has the openings 12A and 13A at positions facing the positions where the tabs t1 and t2 are bonded, and thus occurrence of a short circuit between the first metal layer 12 and the second metal layer 13 can be curbed. When the tabs t1 and t2 are bonded, damage is applied to the resin layer 11. For example, cracking may occur in the resin layer 11. When metal layers are present on both surfaces of the resin layer 11, the first metal layer 12 and the second metal layer 13 may be short-circuited via cracking. If the first metal layer 12 and the second metal layer 13 are short-circuited, the power storage element 200 does not normally function. In contrast, since the current collector according to the first embodiment has the openings 12A and 13A at positions facing the positions where the tabs t1 and t2 are bonded, for example, even when cracking occurs in the resin layer 11, occurrence of a short circuit between the first metal layer 12 and the second metal layer 13 can be curbed. In addition, since the current collector has the openings 12A and 13A at positions facing the positions where the tabs t1 and t2 are bonded, local thickness increase caused by bonding the tabs t1 and t2 can be alleviated. Accordingly, stress generated due to a thickness difference between the bonding locations of the tabs t1 and t2 can be alleviated.

For example, an example in which the current collector 10 described above has the openings 12A and 13A respectively at positions facing the tabs t1 and t2 has been presented, but the opening 12A or the opening 13A may be provided at a position facing any one of the tabs t1 and t2. In this case, a risk of short circuit is further reduced than a case in which both the openings 12A and 13A are not provided.

In addition, the power storage element 200 is not limited to an electrode body and may be a laminate. The laminate is constituted of laminated battery sheets in which the separator 40, the negative electrode active material layer 30, the current collector 10, and the positive electrode active material layer 20 are laminated in this order.

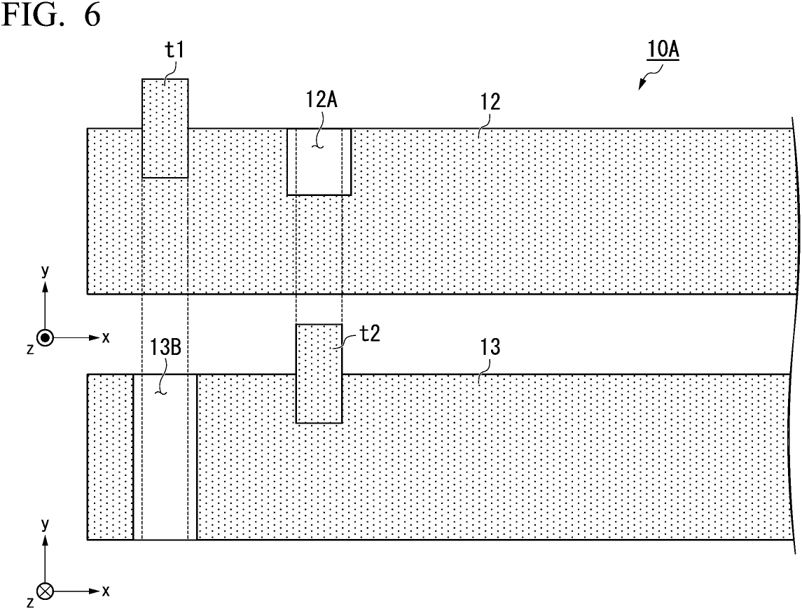

In addition, FIG. 6 is an enlarged plan view of a characteristic part of a current collector 10A according to a first modification example. The current collector 10A differs from the current collector to illustrated in FIG. 5 in shape of an opening 13B. In the current collector 10A, the same reference signs are applied to constitutions similar to those of the current collector 10 illustrated in FIG. 5, and description thereof will be omitted.

The opening 13B is on a side opposite to a region of the first metal layer 12 to which the tab t1 is connected with the resin layer 11 sandwiched therebetween. The opening 13B leads from one end to the other end of the second metal layer 13 in the width direction. The opening 13B leads to the resin layer 11.

### Second Embodiment

A power storage element according to a second embodiment differs from the power storage element 200 according to the first embodiment in shape of a current collector. In the power storage element according to the second embodiment, description of constitutions similar to those of the power storage element 200 according to the first embodiment will be omitted.

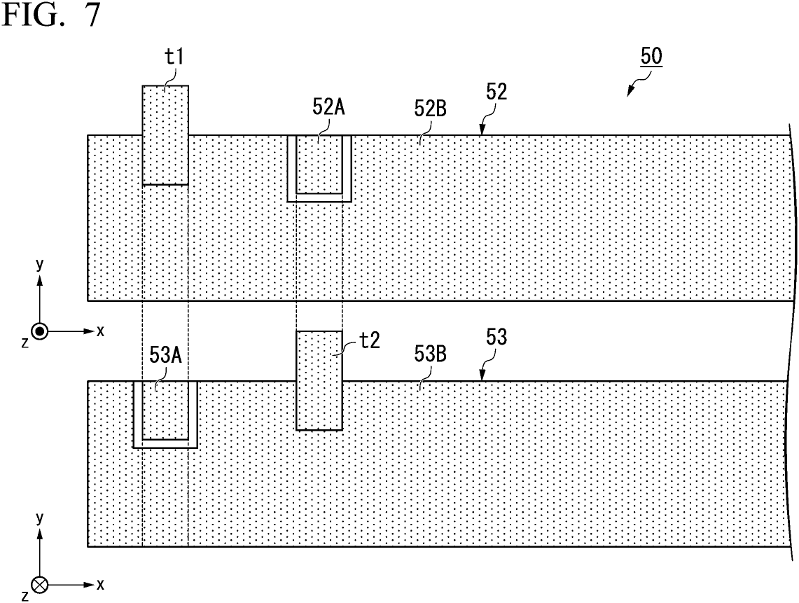

FIG. 7 is an enlarged plan view of a characteristic part of a current collector 50 according to the second embodiment. The current collector 50 includes a resin layer, a first metal layer 52 that is provided on a first surface of the resin layer, and a second metal layer 53 that is provided on a second surface of the resin layer.

The first metal layer 52 has a first region 52A and a second region 52B. In a plan view, the first region 52A is at a position facing the tab bonding location where the tab t2 is bonded in the second metal layer 53. In a plan view, at least a portion of the first region 52A has a part overlapping at least a portion of the tab t2. The second region 52B is a region other than the first region 52A in the first metal layer 52. There is an opening between the first region 52A and the second region 52B, and the first region 52A and the second region 52B are electrically insulated. The opening between the first region 52A and the second region 52B may be filled with an insulator.

The second metal layer 53 has a third region 53A and a fourth region 53B. In a plan view, the third region 53A is at a position facing the tab bonding location where the tab t1 is bonded in the first metal layer 52. In a plan view, at least a portion of the third region 53A has a part overlapping at least a portion of the tab t2. The fourth region 53B is a region other than the third region 53A in the second metal layer 53. There is an opening between the third region 53A and the fourth region 53B, and the third region 53A and the fourth region 53B are electrically insulated. The opening between the third region 53A and the fourth region 53B may be filled with an insulator.

In the current collector 50 according to the second embodiment, the first region 52A and the second region 52B or the third region 53A and the fourth region 53B are insulated. For this reason, for example, even if the first region 52A and the second region 52B or the third region 53A and the fourth region 53B are short-circuited, there is a small influence on behavior of a battery. Therefore, for example, even when cracking occurs in the resin layer 11, an influence on the power storage element can be restricted.

Modification examples similar to those of the power storage element 200 according to the first embodiment can also be applied to the power storage element according to the second embodiment.

### EXAMPLES

### Example 1

An aluminum having a thickness of 2.1 µm was laminated as a first metal layer on a surface of a PET film having a thickness of 6.0 µm. Next, a copper having a thickness of 2.0 µm was laminated as a second metal layer on a surface on a side opposite to the surface of the PET film on which the aluminum was laminated.

Next, openings were formed at predetermined positions in the first metal layer and the second metal layer by photolithography. The openings had shapes similar to that of a region where an attaching tab and the first metal layer or the second metal layer overlapped, and the sizes thereof were further increased by 10% than the region where the attaching tab and the first metal layer or the second metal layer overlapped.

Next, the tabs were respectively connected to the first metal layer and the second metal layer. The tabs were connected at positions facing the respective openings. Further, a potential difference between the first metal layer and the second metal layer was measured. Similar tests were performed with 10 samples. In the current collector of Example 1, no short circuit occurred in any of 10 samples.

### Example 2

As illustrated in FIG. 7, Example 2 differed from Example 1 in that a first region and a second region were respectively formed in the first metal layer and the second metal layer and they were insulated from each other.

Each first region had the same size as the region where the attaching tab and the first metal layer or the second metal layer overlapped. The external shape of each opening between the first region and the second region had a shape similar to that of the region where the attaching tab and the first metal layer or the second metal layer overlapped, and the size thereof was further increased by 10% than the region where the attaching tab and the first metal layer or the second metal layer overlapped.

Next, the tabs were respectively connected to the first metal layer and the second metal layer. The tabs were connected at positions facing each first region. Further, a potential difference between the first metal layer and the second metal layer was measured. Similar tests were performed with 10 samples. In the current collector of Example 2, no short circuit occurred in any of 10 samples.

### Comparative Example 1

Comparative Example 1 differed from Example 1 in that no openings were provided at positions facing locations where tabs were attached. Other conditions were similar to those of Example 1, and tests were performed. In the current collector of Comparative Example 1, 10 samples out of 10 samples were short-circuited.

### Explanation of Reference Signs

10. 10A, 50 Current collector
11 Resin layer
12, 52 First metal layer
12A, 13A, 13B Opening
13. 53 Second metal layer
20 Positive electrode active material layer
30 Negative electrode active material layer
40 Separator
52A, 53A First region
52B, 53B Second region
100 Electrode body
200 Power storage element
C Exterior body
K Accommodation space
t1, t2 Tab

1. A current collector comprising:
a resin layer that has a first surface, and a second surface facing a side opposite to the first surface;
a first metal layer that is provided on the first surface of the resin layer; and
a second metal layer that is provided on the second surface of the resin layer,
wherein the first metal layer has a first opening.

2. The current collector according to claim 1,
wherein the first opening is at a position facing a metal plate bonding location of the second metal layer for bonding a metal plate implementing electrical connection to an external device.

3. The current collector according to claim 1,
wherein the first metal layer has a first region and a second region, and
wherein the first region and the second region are separated from each other by the first opening.

4. The current collector according to claim 1,
wherein the second metal layer has a second opening.

5. The current collector according to claim 4,
wherein the second opening is at a position facing a metal plate bonding location of the first metal layer for bonding a metal plate implementing electrical connection to an external device.

6. The current collector according to claim 4,
wherein the second metal layer has a third region and a fourth region, and
wherein the third region and the fourth region are separated from each other by the second opening.

7. The current collector according to claim 1,
wherein the resin layer is an insulating layer of 1.0×10⁹ Ω•cm or higher.

8. The current collector according to claim 1,
wherein the resin layer includes any one selected from the group consisting of polyethylene terephthalate (PET), polyimide (PI), polyamide imide (PAI), polypropylene (PP), and polyethylene (PE).

9. The current collector according to claim 1,
wherein each of the first metal layer and the second metal layer is any one selected from aluminum, nickel, stainless steel, copper, platinum, and gold.

10. The current collector according to claim 1,
wherein the first metal layer and the second metal layer include metals or alloys different from each other.

11. A power storage element comprising:
the current collector according to claim 1;
a first active material layer that is formed on a first surface of the current collector;
a second active material layer that is formed on a second surface on a side opposite to the first surface of the current collector;
a separator or a solid electrolyte layer that is laminated on one surface of the first active material layer or the second active material layer.

12. A power storage module comprising:
the power storage element according to claim 11.

13. The current collector according to claim 2,
wherein the first metal layer has a first region and a second region, and
wherein the first region and the second region are separated from each other by the first opening.

14. The current collector according to claim 2,
wherein the second metal layer has a second opening.

15. The current collector according to claim 3,
wherein the second metal layer has a second opening.

16. The current collector according to claim 5,
wherein the second metal layer has a third region and a fourth region, and
wherein the third region and the fourth region are separated from each other by the second opening.

17. The current collector according to claim 2,
wherein the resin layer is an insulating layer of 1.0×10⁹ Ω•cm or higher.

18. The current collector according to claim 3,
wherein the resin layer is an insulating layer of 1.0×10⁹ Ω•cm or higher.

19. The current collector according to claim 4,
wherein the resin layer is an insulating layer of 1.0×10⁹ Ω•cm or higher.

20. The current collector according to claim 5,
wherein the resin layer is an insulating layer of 1.0×10⁹ Ω•cm or higher.
